(19) United States
(12) Patent Application Publication
(10) Pub. No.: US 2019/0132485 A1
(43) Pub. Date: May 2, 2019

(54) IMAGE FORMING APPARATUS AND COLOR MISREGISTRATION CORRECTION METHOD

(71) Applicant: CANON KABUSHIKI KAISHA, Tokyo (JP)

(72) Inventors: Katsuhide Koga, Moriya-shi (JP); Takahiro Oonuma, Kashiwa-shi (JP)

(21) Appl. No.: 16/171,839

(22) Filed: Oct. 26, 2018

(30) Foreign Application Priority Data
Oct. 30, 2017 (JP) 2017-209723
Oct. 30, 2017 (JP) 2017-209724

(51) Int. Cl. H04N 1/60; G03G 15/16; H04N 1/00; G03G 15/04; G03G 15/01

(52) U.S. Cl. CPC H04N 1/60; G03G 15/16; G03G 15/0189; G03G 15/04036; H04N 1/00602

(57) ABSTRACT

Provided is an image forming apparatus, which is configured to form measurement images for detecting color misregistration exhibited in a main scanning direction on an intermediate transfer belt in the order of: a measurement image of a reference color, a measurement image of a second color, a measurement image of the reference color, a measurement image of a third color, a measurement image of the reference color, a measurement image of a fourth color, and a measurement image of the reference color in a sub-scanning direction. The image forming apparatus is also configured to detect the measurement images for detecting color misregistration over an entire area of the intermediate transfer belt in the main scanning direction by a line sensor unit, and to correct color misregistration exhibited in the main scanning direction based on detection results.

### BACKGROUND OF THE INVENTION

### Field of the Invention

The present invention relates to an image forming apparatus such as a copying machine or a printer, and more particularly, to a color misregistration correction technology.

### Description of the Related Art

An electrophotographic image forming apparatus includes an image forming unit, an intermediate transfer member, and a fixing device. The image forming unit includes a photosensitive member, a charger, an exposure device, and a developing device. The charger uniformly charges a surface of the photosensitive member. The exposure device exposes the charged surface of photosensitive member, to thereby form an electrostatic latent image on the photosensitive member. The developing device develops the electrostatic latent image to form an image on the photosensitive member. The image formed on the photosensitive member is primarily transferred onto the intermediate transfer member, and then transferred onto a sheet. The intermediate transfer member is rotated in one direction to carry the transferred image to a transfer position at which the image is to be transferred onto the sheet. The image transferred onto the sheet is fixed to the sheet by the fixing device. The image forming apparatus forms an image on a sheet in such a manner. The exposure device scans light on the photosensitive member to form an electrostatic latent image. A scanning direction of the light corresponds to a main scanning direction. The main scanning direction is a direction orthogonal to a rotation direction of the intermediate transfer member. Therefore, the rotation direction of the intermediate transfer member corresponds to a sub-scanning direction.

A tandem-type color image forming apparatus includes four image forming units corresponding to respective colors of yellow, magenta, cyan, and black. Images formed on respective photosensitive members of the image forming units are transferred onto the intermediate transfer member so as to be overlaid on one another. In this case, when misregistration occurs at a position at which the images are to be transferred, color misregistration occurs in an image to be formed in the final stage, and image quality deteriorates. In general, the image forming apparatus has a function of correcting such color misregistration.

The color misregistration correction is performed by forming measurement images of the respective colors for detection of color misregistration on the intermediate transfer member, detecting positions of the measurement images of the respective colors, and measuring a color misregistration amount based on the detected positions. An image forming apparatus described in U.S. Pat. No. 8,587,627 (B2) measures the measurement images through use of a sensor for detection arranged at one end portion in the main scanning direction and a sensor for detection arranged at another end portion in the main scanning direction. The measurement images formed at positions corresponding to the positions of the plurality of sensors for detection allow the color misregistration amount to be accurately measured. Therefore, the color misregistration correction is performed with high accuracy at the positions at which the measurement images are formed. However, no measurement image is formed at a position between the sensors for detection. Therefore, a color misregistration amount at the position between the sensors for detection is calculated by approximate prediction.

However, there is a problem in that, when a scan line formed by the exposure device has a curve or an inclination, color misregistration exhibited in the main scanning direction cannot be corrected with high accuracy. That is, with the configuration including two sensors for detection provided in the main scanning direction, it is not possible to detect an occurrence of the color misregistration within a measuring range of the sensors for detection. Therefore, the image forming apparatus described in U.S. Pat. No. 8,587,627 (B2) cannot correct the color misregistration exhibited between two sensors for detection with high accuracy when the scan line has a curve or an inclination. The present invention has an object to provide an image forming apparatus configured to accurately measure a color misregistration amount through use of a line sensor.

### SUMMARY OF THE INVENTION

An image forming apparatus according to the present disclosure includes: an image bearing member configured to be rotated; a first image forming unit configured to form an image of a first color on the image bearing member; a second image forming unit configured to form an image of a second color different from the first color on the image bearing member; a transfer portion configured to transfer the image of the first color and the image of the second color from the image bearing member onto a sheet; a line sensor, which includes a plurality of light receiving elements arrayed in a direction orthogonal to a rotation direction of the image bearing member, and is configured to read color patterns, each of which being formed on the image bearing member, the plurality of the color pattern being formed in alignment with each other so as to be spaced apart from each other at a predetermined interval in the direction orthogonal to the rotation direction of the image bearing member; and a controller configured to: control the first image forming unit to form a first color pattern of the first color and another first color pattern of the first color, the first color pattern being formed at a position different from a position of the another first color pattern in the rotation direction; control the second image forming unit to form a second color pattern of the second color, the second color pattern being formed between the first color pattern and the another first color pattern in the rotation direction; control the line sensor to read the first color pattern, the another first color pattern, and the second color pattern; detect color misregistration based on reading results of the line sensor; and control relative positions of an image to be formed by the first image forming unit and an image to be formed by the second image forming unit based on the detected color misregistration.

Further features of the present invention will become apparent from the following description of exemplary embodiments (with reference to the attached drawings).

### BRIEF DESCRIPTION OF THE DRAWINGS

FIG. 1 is a configuration view of an image forming apparatus according to an embodiment of the present invention.

FIG. 2A, FIG. 2B, and FIG. 2C are schematic views for illustrating main parts of a line sensor unit.

FIG. 3A and FIG. 3B are explanatory diagrams for illustrating a controller.

FIG. 4 is an explanatory view for illustrating a measurement image for use in measurement of a color misregistration amount in a main scanning direction in a related art.

FIG. 5A and FIG. 5B are explanatory views for illustrating cases in which the color misregistration amount in the main scanning direction cannot be accurately measured.

FIG. 6 is a view for illustrating an example of pattern images for detecting the color misregistration amount in the main scanning direction.

FIG. 7A and FIG. 7B are explanatory graphs for showing detection results of the pattern images.

FIG. 8 is a view for illustrating an example of a measurement image involving color misregistration.

FIG. 9 is a view for illustrating another example of the measurement image involving color misregistration exhibited in the main scanning direction.

FIG. 10 is an explanatory graph for showing detection results of the measurement image illustrated in FIG. 9.

FIG. 11A is an explanatory view for illustrating the measurement image, and FIG. 11B is an explanatory graph for showing detection results of the measurement image.

FIG. 12A and FIG. 12B are explanatory views for illustrating measurement images for detecting color misregistration exhibited in a sub-scanning direction, and FIG. 12C is an explanatory graph for showing a relationship between detection timings and positions of pattern images.

FIG. 13 is an explanatory view for illustrating a measurement image for use in the measurement of the color misregistration amount in the main scanning direction in the related art.

FIG. 14A, FIG. 14B, and FIG. 14C are explanatory diagrams and explanatory graphs for showing detection results of the measurement image in the related art.

FIG. 15A and FIG. 15B are an explanatory diagram and explanatory graphs for showing the detection results of the measurement image in the related art.

FIG. 16 is a view for illustrating an example of a measurement image for detecting color misregistration exhibited in the main scanning direction in the embodiment.

FIG. 17A, FIG. 17B, and FIG. 17C are explanatory graphs for showing detection results of the measurement image illustrated in FIG. 16.

FIG. 18 is an explanatory view and an explanatory graph for showing a center position and misregistration of the center position.

FIG. 19 is an explanatory view for illustrating a measurement image for detecting color misregistration exhibited in the sub-scanning direction.

### DESCRIPTION OF THE EMBODIMENTS

Now, an embodiment of the present invention is described in detail with reference to the accompanying drawings.

Image Forming Apparatus

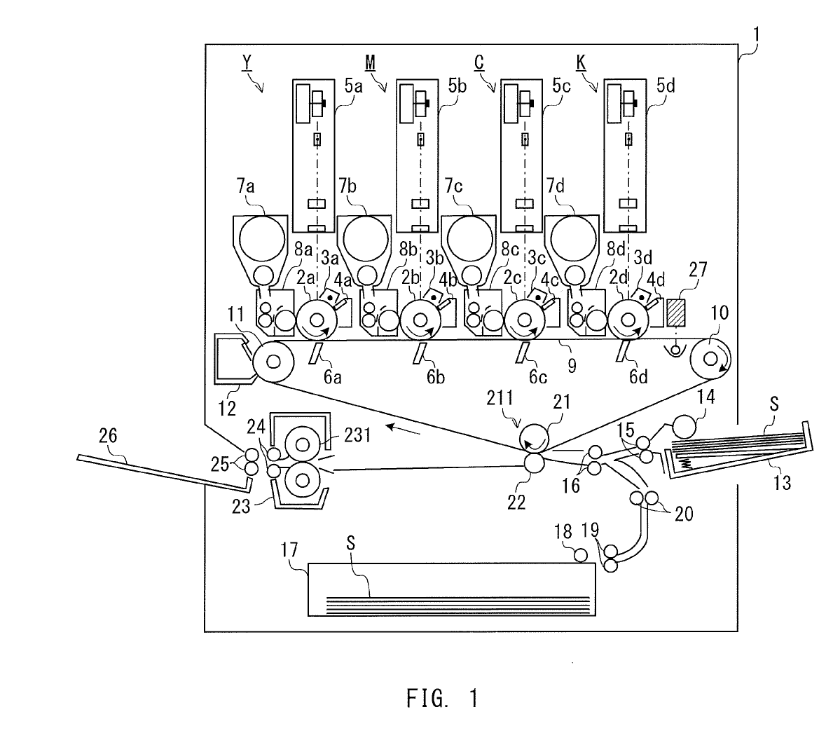

FIG. 1 is a configuration view of an image forming apparatus according to this embodiment. This image forming apparatus is, for example, an electrophotographic full-color printer. An image forming apparatus 1 includes image forming units Y, M, C, and K configured to form images of different colors (four colors in this case), an intermediate transfer belt 9, and a fixing device 23. The image forming apparatus 1 includes a sheet feeding cassette 17 and a manual feed tray 13 that are configured to store sheets S. The image forming apparatus 1 forms an image on a sheet S fed from the sheet feeding cassette 17 or the manual feed tray 13, and delivers the sheet S onto the delivery tray 26.

The image forming unit Y forms an image of yellow. The image forming unit M forms an image of magenta. The image forming unit C forms an image of cyan. The image forming unit K forms an image of black. The image forming units Y, M, C, and K have the same configuration, and are different only in the color of the image to be formed. In the following, description is given of the configuration of the image forming unit Y, and description of the configurations of the image forming units M, C, and K is omitted.

The image forming unit Y includes a developing unit 7a, a primary transfer portion 6a, and a cleaner 4a. The developing unit 7a includes a photosensitive drum 2a, a charger 3a, an exposure device 5a, and a developing device 8a. The photosensitive drum 2a is a photosensitive member having a drum shape, and is rotated counterclockwise in FIG. 1. The charger 3a uniformly charges a surface of the photosensitive drum 2a being rotated. The exposure device 5a irradiates the uniformly charged surface of the photosensitive drum 2a with light based on predetermined image data to form an electrostatic latent image on the photosensitive drum 2a based on the image data. The exposure device 5a includes, for example, a semiconductor laser as a light source, and scans laser light on the photosensitive drum 2a, to thereby form an electrostatic latent image. The developing device 8a develops the electrostatic latent image with a developer to form an image (developer image) of yellow on the photosensitive drum 2a. For example, the developing device 8a develops the electrostatic latent image with a toner of yellow, to thereby form a toner image of yellow on the photosensitive drum 2a. The primary transfer portion 6a transfers the toner image formed on the photosensitive drum 2a onto the intermediate transfer belt 9. The cleaner 4a removes a toner remaining on the photosensitive drum 2a after the transfer.

In the same manner, the image forming unit M forms a toner image of magenta on a photosensitive drum 2b. The image forming unit C forms a toner image of cyan on a photosensitive drum 2c. The image forming unit K forms a toner image of black on a photosensitive drum 2d. The toner images of the respective colors formed on the photosensitive drums 2b, 2c, and 2d are transferred onto the intermediate transfer belt 9 by the primary transfer portions 6b, 6c, and 6d, respectively.

The intermediate transfer belt 9 is a transferring member stretched around rollers 10 and 11 and a rotation roller 21 to be rotated clockwise in FIG. 1. The intermediate transfer belt 9 receives the toner images sequentially transferred from the respective photosensitive drums 2a, 2b, 2c, and 2d in accordance with the rotation. When color misregistration is accurately corrected, a full-color toner image involving no color misregistration is formed on the intermediate transfer belt 9. The intermediate transfer belt 9 is rotated, to thereby carry the toner image to a secondary transfer portion 211 formed of the rotation roller 21 and a secondary transfer roller 22. The image forming units Y, M, C, and K are arranged in the order of the image forming unit Y, the image forming unit M, the image forming unit C, and the image forming unit K from upstream in a rotation direction (image carrying direction) of the intermediate transfer belt 9. A line sensor unit 27 for detecting the position of an image formed on the intermediate transfer belt 9 is provided on downstream of the image forming unit K in the rotation direction of the intermediate transfer belt 9.

The sheets S stored in the sheet feeding cassette 17 are fed by pickup rollers 18 and 19 one by one, and conveyed to registration rollers 16 via vertical path rollers 20. The sheets S stored in the manual feed tray 13 are fed by pickup rollers 14 and 15 one by one, and conveyed to the registration rollers 16. The registration rollers 16 correct, for example, skew feed of a sheet S, and conveys the sheet S to the secondary transfer portion 211 in accordance with a timing at which the intermediate transfer belt 9 carries the toner image to the secondary transfer portion 211. The rollers for conveying the sheet S are driven by separately provided stepping motors, respectively, in order to achieve the conveying operation of the sheet S at high speed with stability. The secondary transfer portion 211 transfers the toner image borne on the intermediate transfer belt 9 onto the sheet S. A toner remaining on the intermediate transfer belt 9 after the transfer is removed by an intermediate transfer belt cleaner 12.

The sheet S having the toner images transferred thereonto is conveyed from the secondary transfer portion 211 to the fixing device 23. The fixing device 23 includes a fixing roller 231 and inner delivery rollers 24. The fixing roller 231 heats and pressurizes the sheet S onto which the toner image has been transferred, to thereby fix the toner to the sheet S. With this fixation, the image is formed on the sheet S. The inner delivery rollers 24 convey the sheet S having the image formed thereon to delivery rollers 25. The delivery rollers 25 deliver the sheet S conveyed from the fixing device 23 onto the delivery tray 26.

The image forming apparatus 1 forms an image on the sheet S as described above. In the following description, a direction in which light emitted from the exposure devices 5a to 5d is scanned on the photosensitive drums 2a to 2d (depth direction in FIG. 1) is referred to as “main scanning direction”, while a direction orthogonal to the main scanning direction is referred to as “sub-scanning direction”. The sub-scanning direction is the same direction as the rotation direction of the intermediate transfer belt 9.

Line Sensor Unit

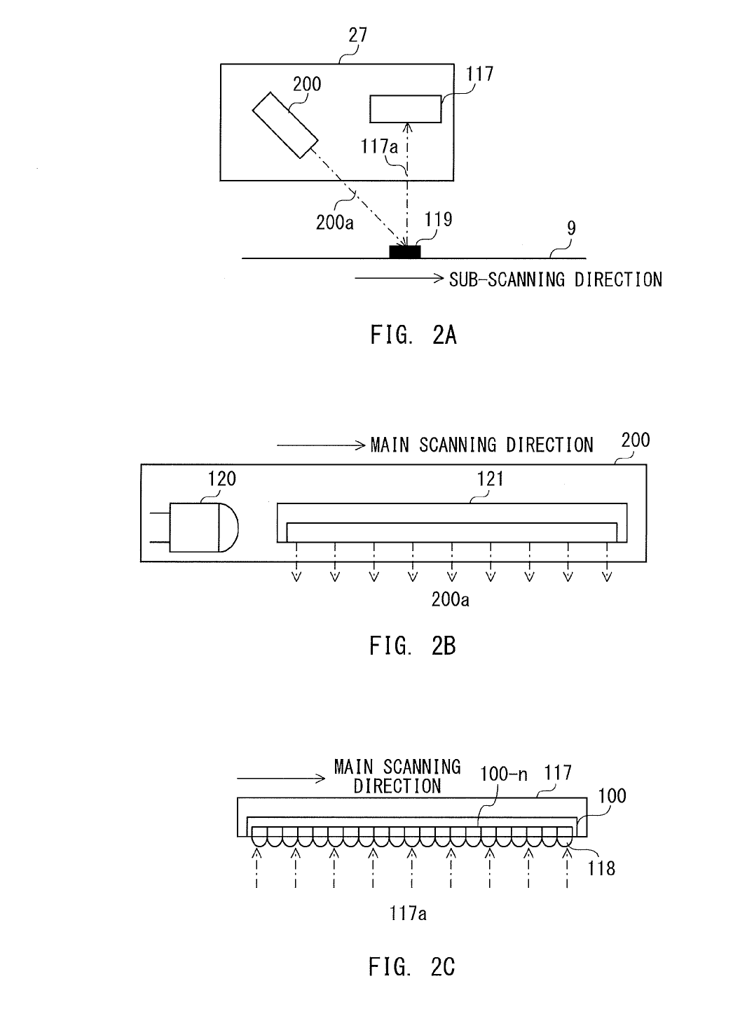

FIG. 2A to FIG. 2C are schematic views for illustrating main parts of the line sensor unit 27. FIG. 2A is an explanatory view for illustrating a configuration and an operation of the line sensor unit 27. The image forming apparatus 1 forms a pattern image (measurement image) to be used for detecting a color misregistration amount on the intermediate transfer belt 9. The line sensor unit 27 includes a light emitter 200 and a light receiving unit 117. The light emitter 200 emits light 200a to the intermediate transfer belt 9. The light receiving unit 117 receives the reflected light 117a being the light 200a reflected by the intermediate transfer belt 9. The line sensor unit 27 measures a measurement image 119 borne on the intermediate transfer belt 9. When the line sensor unit 27 is to measure the measurement image 119, the light receiving unit 117 receives the reflected light 117a being the light 200a reflected by the measurement image 119. The line sensor unit 27 measures the reflected light 117a from the intermediate transfer belt 9 and the measurement image 119 within a measuring range.

FIG. 2B is a schematic view for illustrating main parts of the light emitter 200. The light emitter 200 includes a light emitting element 120 and a light guide 121. The light emitting element 120 is, for example, a light emitting diode (LED), and emits light to the light guide 121. The light guide 121 converts the light emitted from the light emitting element 120. The light 200a converted by the light guide 121 is projected onto the intermediate transfer belt 9. The light guide 121 is arranged such that a long side of the light guide 121 is parallel with the main scanning direction. Therefore, the light 200a is applied to the surface of the intermediate transfer belt 9 linearly in the main scanning direction. In this case, the length of the light 200a applied to the intermediate transfer belt 9 in the main scanning direction is substantially the same as the length of the intermediate transfer belt 9 in the main scanning direction.

FIG. 2C is a schematic view for illustrating main parts of the light receiving unit 117. The light receiving unit 117 includes: a line sensor 100 including a plurality of light receiving elements 100-n arrayed in the main scanning direction; and SELFOC (trademark) lenses 118. The reflected light 117a from the intermediate transfer belt 9 and the reflected light 117a from the measurement image 119 borne on the intermediate transfer belt 9 are received by the light receiving elements 100-n of the line sensor 100 via the SELFOC (trademark) lenses 118. The number of the plurality of light receiving elements 100-n that are arrayed and the number of the SELFOC (trademark) lenses 118 that are arrayed are each 8,000, for example. The symbol “n” represents a natural number, and indicates a pixel position in the main scanning direction. The SELFOC (trademark) lenses 118 suppress deterioration in measurement accuracy of the light receiving elements 100-n even when a distance between each of the light receiving elements 100-n and the measurement image 119 varies.

Controller

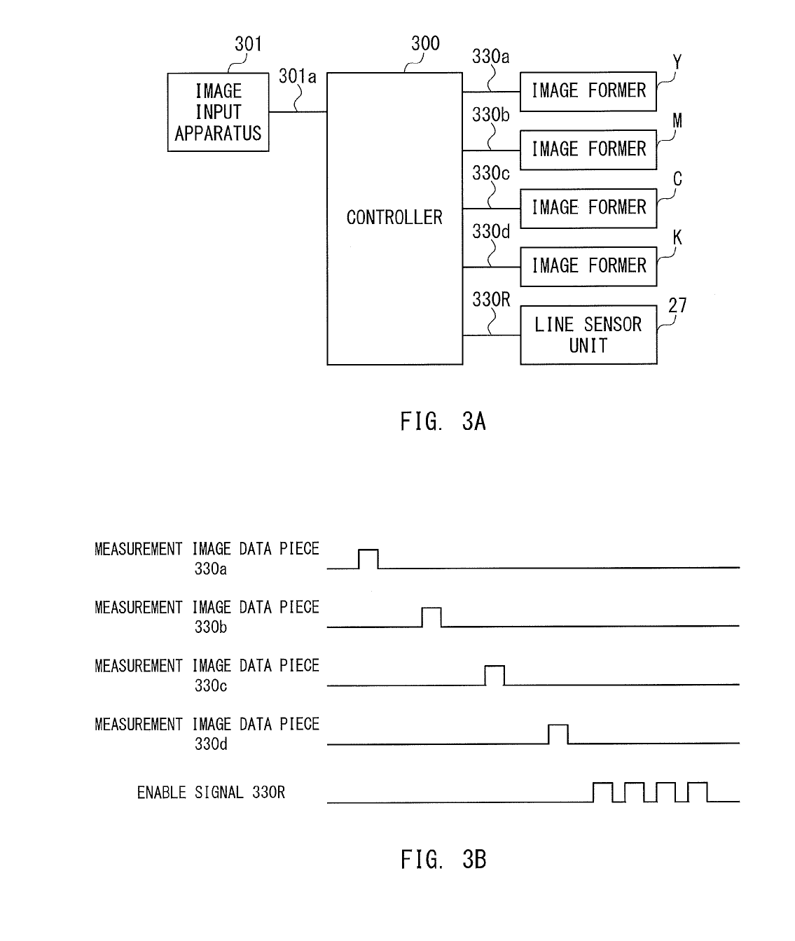

FIG. 3A and FIG. 3B are explanatory diagrams for illustrating a controller configured to control an operation of the image forming apparatus 1. FIG. 3A is a control block diagram of the image forming apparatus 1. FIG. 3B is a timing chart of signals for forming measurement images of the respective colors.

A controller 300 controls the operation of the image forming apparatus 1. The controller 300 includes a central processing unit (CPU), a read only memory (ROM), a random access memory (RAM), and a memory. The ROM stores a control program to be executed by the CPU and data. The RAM functions as a system work memory. In the following, description is given of a function of the controller 300 for color misregistration correction. The controller 300 is connected to an image input apparatus 301, the image forming units Y, M, C, and K, and the line sensor unit 27.

The controller 300 sequentially transmits measurement image data pieces 330a to 330d for forming measurement images (pattern images) of the respective colors to the image forming units Y, M, C, and K, and causes the image forming units Y, M, C, and K to form measurement images (pattern images), respectively. The measurement image data piece 330a is data for forming the pattern image of yellow. The measurement image data piece 330b is data for forming the pattern image of magenta. The measurement image data piece 330c is data for forming the pattern image of cyan. The measurement image data piece 330d is data for forming the pattern image of black.

The image forming units Y, M, C, and K form pattern images on the photosensitive drums 2a to 2d based on the measurement image data pieces 330a to 330d, respectively. The pattern images of the respective colors formed on the photosensitive drums 2a to 2d are transferred onto the intermediate transfer belt 9. At timings illustrated in FIG. 3B, the measurement image data pieces 330a to 330d are transmitted from the controller 300 to the image forming units Y, M, C, and K, respectively. With this processing, the measurement images of the respective colors are formed on the intermediate transfer belt 9 at predetermined intervals.

The controller 300 transmits enable signals 330R to the line sensor unit 27 at a timing at which the pattern image formed on the intermediate transfer belt 9 passes through the measuring range of the line sensor unit 27. The line sensor unit 27 acquires the enable signals 330R, and performs a detection operation to measure the reflected light from the pattern images.

The controller 300 acquires detection results corresponding to a plurality of detection operations from the line sensor unit 27, and detects the color misregistration amount of other colors with respect to a reference color based on those detection results. Then, the controller 300 generates color misregistration correction data corresponding to the color misregistration amount. The controller 300 stores the generated color misregistration correction data in the memory, and uses the generated color misregistration correction data for color misregistration correction processing at a time of image formation.

The image input apparatus 301 is, for example, a scanner, and transfers image data representing an image (output image) to be formed on the sheet S to the controller 300. The controller 300 performs image processing (color misregistration correction) based on the color misregistration correction data on the image data transferred from the image input apparatus 301, and transfers the processed image data to the image forming units Y, M, C, and K. The exposure devices 5a to 5d of the image forming units Y, M, C, and K form electrostatic latent images on the photosensitive drums 2a to 2d based on the image data subjected to the color misregistration correction. After the electrostatic latent images are developed and transferred, the output image subjected to the color misregistration correction is formed on the sheet S.

Influence on Color Misregistration Correction by Skew of Measurement Image and Curve or Inclination of Scan Line

Now, a description is given of influences exerted on the color misregistration correction by skew of the measurement image formed on the intermediate transfer belt 9 and a curve or inclination of a scan line. The scan line is a path obtained when the light emitted from the exposure devices 5a to 5d is scanned on the photosensitive drums 2a to 2d, respectively.

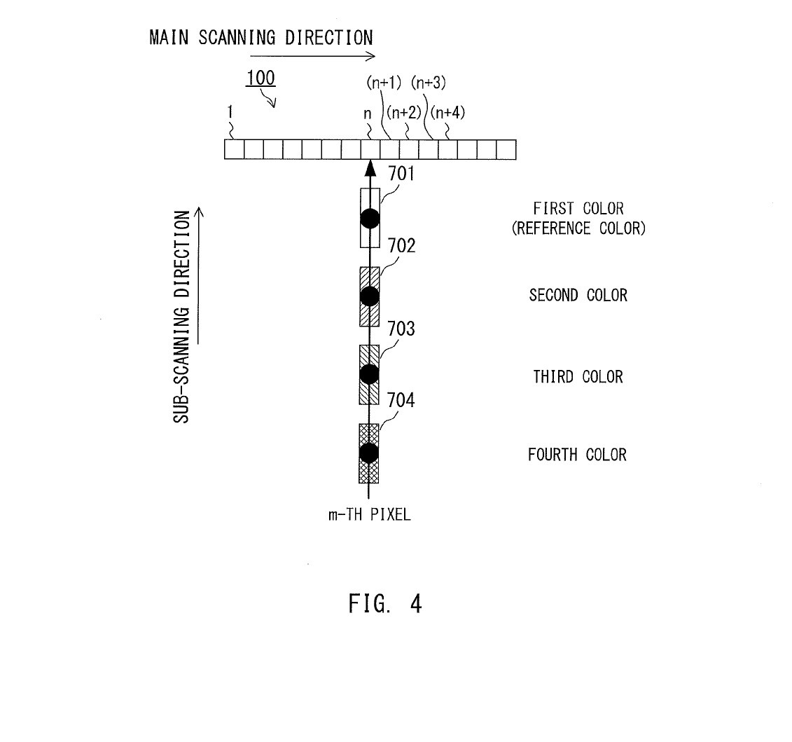

FIG. 4 is a schematic view for illustrating pattern images to be used for detecting the color misregistration amount in the main scanning direction. The pattern images include a pattern image 701 of a first color being the reference color, a pattern image 702 of a second color, a pattern image 703 of a third color, and a pattern image 704 of a fourth color, which are arrayed in the sub-scanning direction. In this case, the widths of the pattern images 701 to 704 of the respective colors in the main scanning direction are assumed to be the same as the width of one pixel of the line sensor 100 in the main scanning direction. An interval between each adjacent pair of the pattern images in the main scanning direction is also assumed to be the same as the width of one pixel of the line sensor 100.

Solid circles illustrated in FIG. 4 indicate respective center positions of the pattern images in the main scanning direction. The color misregistration amount in the main scanning direction is measured as, for example, a difference in position between the center position of the pattern image of the reference color in the main scanning direction and the center position of the pattern image of another color in the main scanning direction. In FIG. 4, the pattern images 702, 703, and 704 are each formed to have the center position in the main scanning direction at the same position as the center position of the pattern image 701 in the main scanning direction. In addition, the image carrying direction of the intermediate transfer belt 9 is parallel with the sub-scanning direction. Therefore, the pattern image of each color is read by an n-th (i.e., n^{th}) light receiving element 100-n of the line sensor 100 in the main scanning direction. The pattern images 701, 702, 703, and 704 of all the four colors are read by the light receiving elements 100-n, and hence the color misregistration amount in the main scanning direction is detected as “0”.

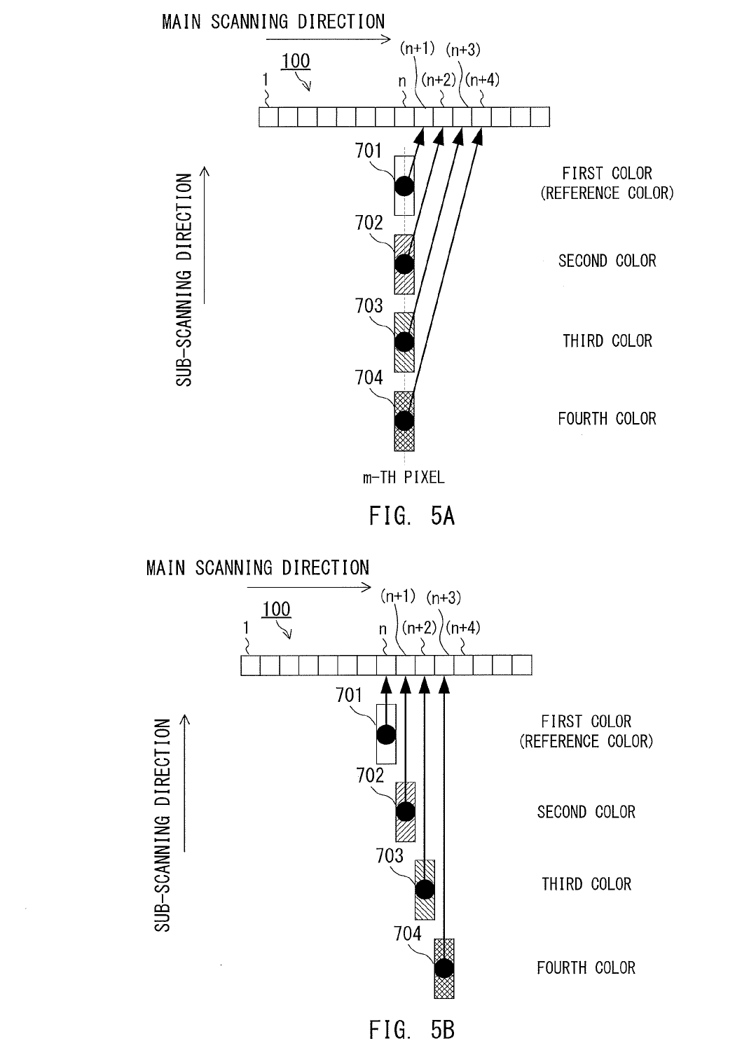

FIG. 5A and FIG. 5B are other schematic views for illustrating pattern images to be used for detecting the color misregistration amount in the main scanning direction.

Due to the rotation of the intermediate transfer belt 9, the pattern images 701, 702, 703, and 704 that are illustrated in FIG. 5A are skewed. In the same manner as in FIG. 4, the pattern images of the respective colors are formed at equal intervals in the main scanning direction and the sub-scanning direction. Therefore, when the intermediate transfer belt 9 is not skewed, the color misregistration amount in the main scanning direction is “0”.

However, in FIG. 5A, the intermediate transfer belt 9 is skewed in the upper right direction. Thus, the pattern image 701 of the first color being the reference color is read by an (n+1)-th light receiving element 100-(n+1) of the line sensor 100 in the main scanning direction. The pattern image of the second color is read by an (n+2)-th light receiving element 100-(n+2) of the line sensor 100 in the main scanning direction. The pattern image of the third color is read by an (n+3)-th light receiving element 100-(n+3) of the line sensor 100 in the main scanning direction. The pattern image of the fourth color is read by an (n+4)-th light receiving element 100-(n+4) of the line sensor 100 in the main scanning direction.

Therefore, when the intermediate transfer belt 9 is skewed, the relative positions of the pattern images may be erroneously detected. This inhibits the color misregistration amount from being detected with high accuracy.

FIG. 5B is different from FIG. 5A in that the intermediate transfer belt 9 is not skewed. However, the pattern images 701, 702, 703, and 704 that are illustrated in FIG. 5B are formed on the intermediate transfer belt 9 with the pattern images of the respective colors being displaced in the main scanning direction by one pixel. In this case, the same color misregistration amount as in FIG. 5A is detected. As illustrated in FIG. 5A and FIG. 5B, even when similar color misregistration is detected in the main scanning direction, actual color misregistration amount of the pattern image formed on the intermediate transfer belt 9 may differ. Thus, even when pattern images are formed for respective colors, it is difficult to detect the actual color misregistration amount in the main scanning direction with high accuracy.

In view of the foregoing, the image forming apparatus 1 according to this embodiment suppresses the influences of the skew of the intermediate transfer belt 9 and the curve or inclination of a scan line, and forms measurement images for detecting the color misregistration amounts in the main scanning direction and the sub-scanning direction with high accuracy.

Color Misregistration Detection in Main Scanning Direction

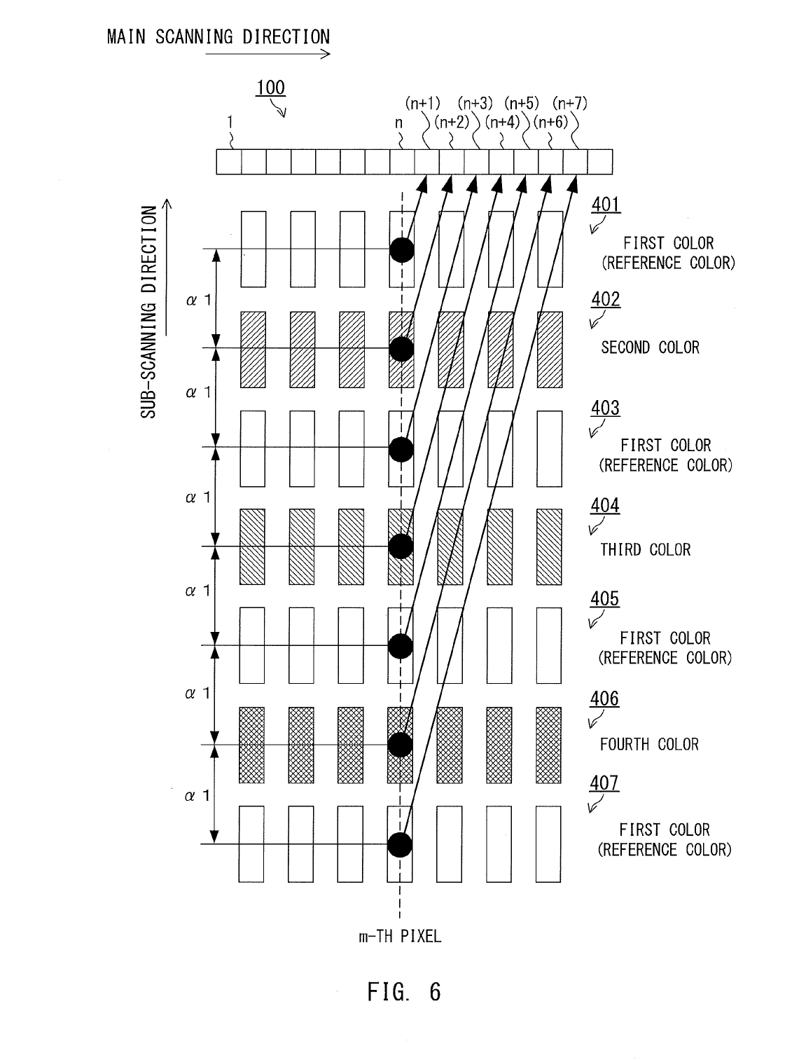

FIG. 6 is a view for illustrating an example of pattern image groups 401, 402, 403, 404, 405, 406, and 407 for detecting color misregistration exhibited in the main scanning direction in this embodiment. In each of the pattern image groups 401, 402, 403, 404, 405, 406, and 407, pattern images of the same color are arrayed in the main scanning direction at equal intervals. The pattern image groups 401, 402, 403, 404, 405, 406, and 407 are formed over the substantially entire area of the intermediate transfer belt 9 in the main scanning direction. The pattern image groups 401, 402, 403, 404, 405, 406, and 407 are formed so that the pattern image groups 401, 403, 405, and 407 of the reference color and the pattern image groups 402, 404, and 406 of other colors are arrayed alternately in the sub-scanning direction. The pattern image groups 401, 402, 403, 404, 405, 406, and 407 are each formed of a plurality of rectangular pattern images that are long in the sub-scanning direction. A plurality of pattern images of the same color arrayed in the main scanning direction form a pattern image group of the color.

In the image forming apparatus 1 according to this embodiment, the first color is set as the reference color. The pattern image groups 401, 402, 403, 404, 405, 406, and 407 of the respective colors are arranged in the following manner in the order of being read by the line sensor 100 of the line sensor unit 27 in the sub-scanning direction. First, the pattern image group 401 of the first color is arranged. The pattern image group 402 of the second color is arranged after the pattern image group 401 of the first color. The pattern image group 403 of the first color is arranged after the pattern image group 402 of the second color. The pattern image group 404 of the third color is arranged after the pattern image group 403 of the first color. The pattern image group 405 of the first color is arranged after the pattern image group 404 of the third color. The pattern image group 406 of the fourth color is arranged after the pattern image group 405 of the first color. The pattern image group 407 of the first color is arranged after the pattern image group 406 of the fourth color. The pattern image groups 401 to 407 of the respective colors are formed so as to have a predetermined interval α1 in the sub-scanning direction.

When the respective pattern images are formed so as to be arrayed at equal intervals in the main scanning direction and the sub-scanning direction, for example, the light receiving element 100-n reads an m-th pattern image formed in the main scanning direction. Each of the solid circles illustrated in FIG. 6 indicates the center position (barycenter) of the m-th pattern image in the main scanning direction.

In this case, when the intermediate transfer belt 9 is not skewed, the m-th pattern images in the main scanning direction (hereinafter simply referred to as “m-th pattern images”) of the pattern image groups 401, 403, 405, and 407 of the first color (reference color) are read by the same light receiving element 100-n. However, in FIG. 6, the intermediate transfer belt 9 is skewed. Therefore, the m-th pattern images are read by different light receiving elements.

For example, the m-th pattern image of the pattern image group 401 of the first color is read by an (n+1)-th light receiving element 100-(n+1) of the line sensor unit 27. The m-th pattern image of the pattern image group 402 of the second color is read by an (n+2)-th light receiving element 100-(n+2). The m-th pattern image of the pattern image group 403 of the first color is read by an (n+3)-th light receiving element 100-(n+3). The m-th pattern image of the pattern image group 404 of the third color is read by an (n+4)-th light receiving element 100-(n+4). The m-th pattern image of the pattern image group 405 of the first color is read by an (n+5)-th light receiving element 100-(n+5). The m-th pattern image of the pattern image group 406 of the fourth color is read by an (n+6)-th light receiving element 100-(n+6). The m-th pattern image of the pattern image group 407 of the first color is read by an (n+7)-th light receiving element 100-(n+7).

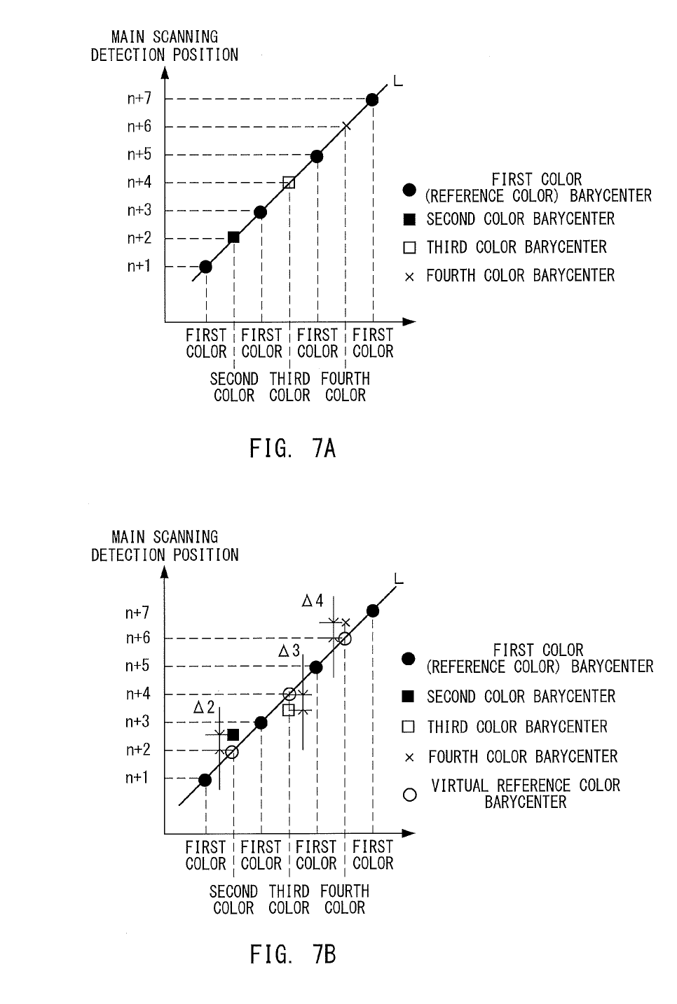

FIG. 7A is an explanatory graph for showing detection results of the pattern image groups 401 to 407 obtained under a state in which the intermediate transfer belt 9 is skewed. In FIG. 7A, the horizontal axis represents a timing at which the m-th pattern image of each of the pattern image groups 401 to 407 has been read, and the vertical axis represents the light receiving element that has read the m-th pattern image.

As described above, the m-th pattern images of the pattern image groups 401, 403, 405, and 407 of the first color are detected by the different light receiving elements. The positions of the light receiving elements that detect the m-th pattern images of the pattern image groups 401, 403, 405, and 407 of the first color (reference color) are present on a straight line L connecting the solid circles illustrated in FIG. 7A. The straight line L represents virtual timings to read the m-th pattern images of the first color being the reference color.

Therefore, it is understood that, at a timing at which the m-th pattern image of the pattern image group 402 of the second color is being read, the m-th pattern image of the pattern image group 401 of the first color is located at a position corresponding to the light receiving element 100-(n+2). When the m-th pattern image of the pattern image group 402 of the second color is being read by the light receiving element 100-(n+2) at this timing, a color misregistration amount between the pattern image group 401 of the first color and the pattern image group 402 of the second color is “0”.

Similarly, at a timing at which the m-th pattern image of the pattern image group 404 of the third color is being read, the m-th pattern image of the pattern image group 401 of the first color is located at a position corresponding to the light receiving element 100-(n+4). When the m-th pattern image of the pattern image group 404 of the third color is being read by the light receiving element 100-(n+4) at this timing, a color misregistration amount between the pattern image group 401 of the first color and the pattern image group 404 of the third color is “0”.

At a timing at which the m-th pattern image of the pattern image group 406 of the fourth color is being read, the m-th pattern image of the pattern image group 401 of the first color is located at a position corresponding to the light receiving element 100-(n+6). When the m-th pattern image of the pattern image group 406 of the fourth color is being read by the light receiving element 100-(n+6) at this timing, a color misregistration amount between the pattern image group 401 of the first color and the pattern image group 406 of the fourth color is “0”.

FIG. 7B is a graph for showing detection results obtained when the timings to read the m-th pattern images of the pattern image groups 402, 404, and 406 fall out of the straight line L connecting the solid circles. The m-th pattern image of the pattern image group 402 of the second color is read with color misregistration at a position shifted by Δ2 from the light receiving element 100-(n+2) to the light receiving element 100-(n+3) side (above the straight line L). The m-th pattern image of the pattern image group 404 of the third color is read with color misregistration at a position shifted by Δ3 from the light receiving element 100-(n+4) to the light receiving element 100-(n+3) side (below the straight line L). The m-th pattern image of the pattern image group 406 of the fourth color is read with color misregistration at a position shifted by Δ4 from the light receiving element 100-(n+6) to the light receiving element 100-(n+7) side (above the straight line L).

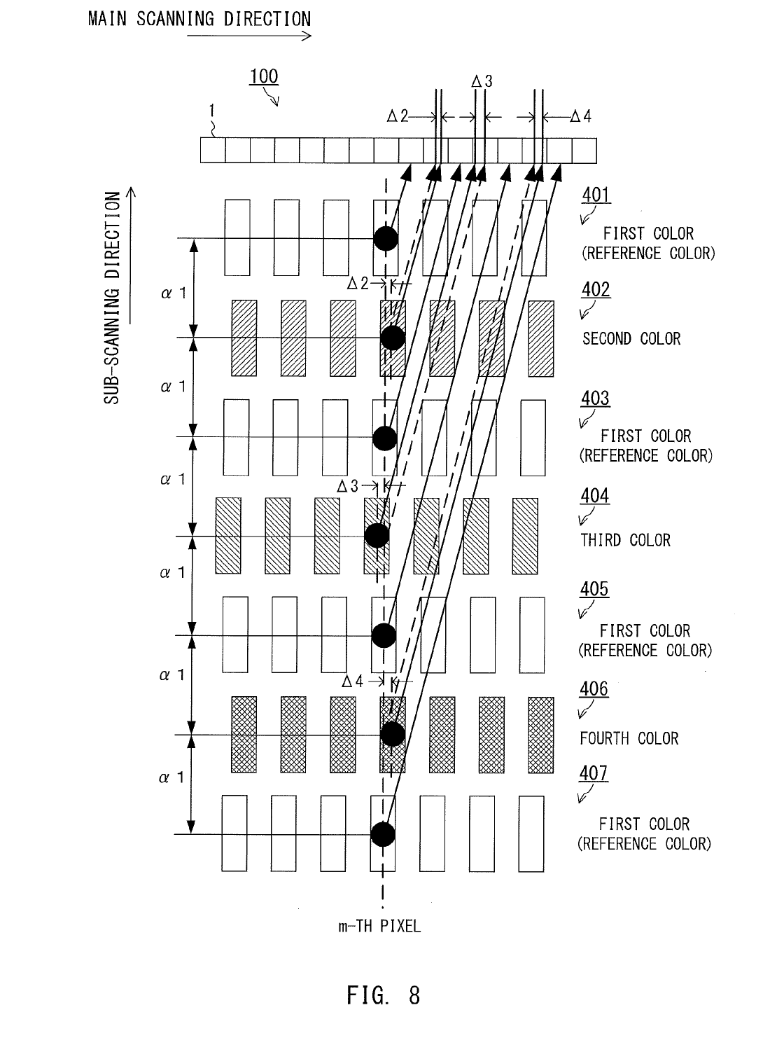

FIG. 8 is a view for illustrating an example of a measurement image involving color misregistration, which exhibits such measurement results as illustrated in FIG. 7B. The pattern image group 402 of the second color is formed with color misregistration at a position shifted by Δ2 from the pattern image groups 401, 403, 405, and 407 of the first color (reference color) in the positive direction in the main scanning direction. The pattern image group 404 of the third color is formed with color misregistration at a position shifted by Δ3 from the pattern image groups 401, 403, 405, and 407 of the first color (reference color) in the negative direction in the main scanning direction. The pattern image group 406 of the fourth color is formed with color misregistration at a position shifted by Δ4 from the pattern image groups 401, 403, 405, and 407 of the first color (reference color) in the positive direction in the main scanning direction.

As shown in FIG. 7B and illustrated in FIG. 8, the timings (virtual reference color positions) at which the pattern images of the reference color are read are indicated by the straight line L representing a relationship between the detection timings of the pattern image groups 401, 403, 405, and 407 of the first color (reference color) and the light receiving elements. The controller 300 measures differences Δ2, Δ3, and Δ4 between the virtual reference color positions and the positions of the pattern images of the other colors read at the same timings. This enables the controller 300 to measure the accurate color misregistration amount of each color with respect to the reference color in the main scanning direction even when the intermediate transfer belt 9 is skewed. The controller 300 can correct the color misregistration amount in the main scanning direction with high accuracy by generating such color misregistration correction data as to correct the differences Δ2, Δ3, and Δ4 from the virtual reference color positions.

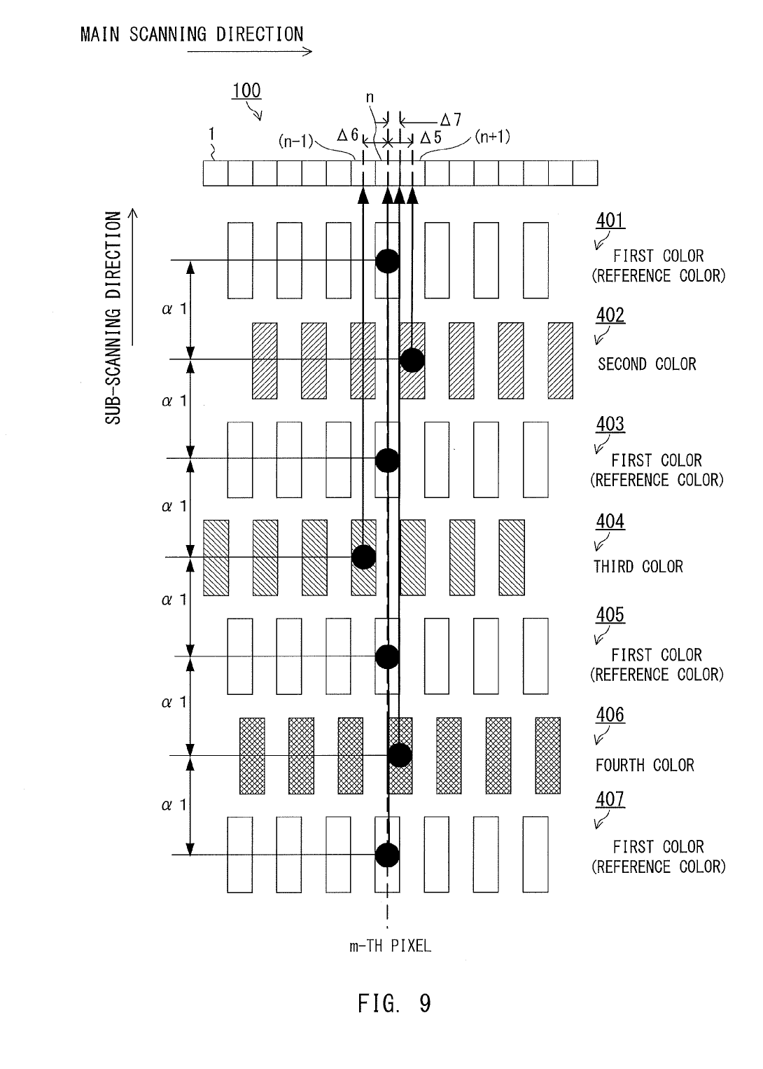

FIG. 9 is a view for illustrating another example of the pattern images involving color misregistration exhibited in the main scanning direction. The pattern image group 402 of the second color is formed with color misregistration at a position shifted by Δ5 from the pattern image groups 401, 403, 405, and 407 of the first color (reference color) in the positive direction in the main scanning direction. The pattern image group 404 of the third color is formed with color misregistration at a position shifted by Δ6 from the pattern image groups 401, 403, 405, and 407 of the first color (reference color) in the negative direction in the main scanning direction. The pattern image group 406 of the fourth color is formed with color misregistration at a position shifted by Δ7 from the pattern image groups 401, 403, 405, and 407 of the first color (reference color) in the positive direction in the main scanning direction.

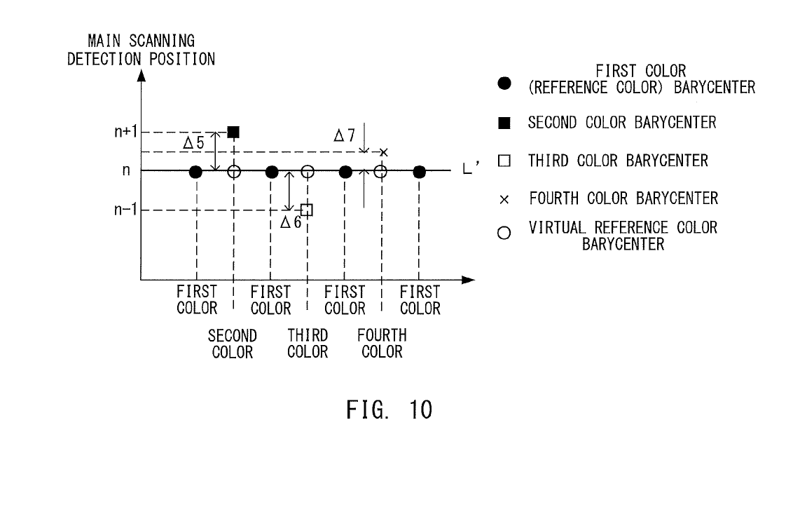

In FIG. 9, the pattern images are read under a state in which the intermediate transfer belt 9 is not skewed. FIG. 10 is an explanatory graph for showing detection results of the pattern images in FIG. 9 obtained by the line sensor 100. The controller 300 measures a difference between the virtual reference color positions (outlined circles) on a straight line L′ connecting the detection results of the pattern images (solid circles) of the first color (reference color) and detection positions of the pattern images of the respective colors, to thereby be able to detect an accurate color misregistration amount of the image of each color with respect to the image of the reference color.

As described above, in order to detect the color misregistration amount in the main scanning direction, the image forming apparatus 1 according to this embodiment forms the pattern image groups 401, 403, 405, and 407 of the reference color (first color) and the pattern image groups 402, 404, and 406 of the other colors (second to fourth colors) alternately in the sub-scanning direction. The controller 300 determines the virtual reference color positions based on the detection results of the pattern images of the pattern image groups 401, 403, 405, and 407 of the reference color at the same positions in the main scanning direction. Then, the controller 300 calculates differences between the virtual reference color positions and the detection positions of the pattern images of the respective colors, to thereby be able to remove skew components on the intermediate transfer belt 9 and detect the accurate color misregistration amount in the main scanning direction. The controller 300 can measure the color misregistration amount for an entire area in the main scanning direction by performing the above-mentioned measurement of the color misregistration amount on the entire area in the main scanning direction. Therefore, it is possible to measure the accurate color misregistration amount even for a part in which the color misregistration amount has been estimated hitherto without a sensor for detection being arranged, and it is possible to measure the color misregistration amount with higher accuracy.

The pattern images for detecting color misregistration exhibited in the main scanning direction may be not only formed so that the pattern images of the first color being the reference color and the pattern images of the second to fourth colors are arranged alternately in the sub-scanning direction, but also formed so that the pattern images of the second to fourth colors are sandwiched by the pattern images of the first color in the sub-scanning direction.

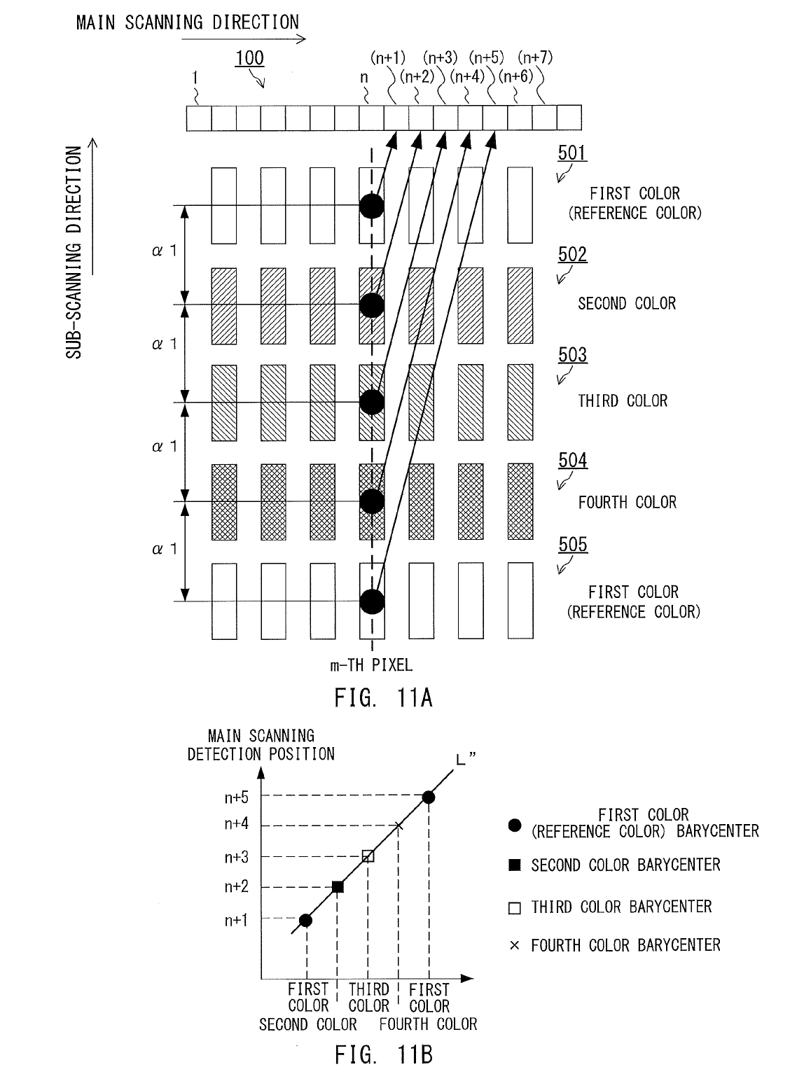

FIG. 11A is a schematic view for illustrating such pattern images. As illustrated in FIG. 11A, as the pattern images, pattern image groups 501 and 505 of the first color being the reference color are arranged on upstream and downstream, respectively, of pattern image groups 502 to 504 of the second to fourth colors, respectively, in the sub-scanning direction. FIG. 11B is an explanatory graph for showing detection results of the pattern images in FIG. 11A obtained by the line sensor 100. The positions of the light receiving elements that detect the m-th pattern images of the pattern image groups 501 and 505 of the first color (reference color) are indicated by a straight line L″ connecting the solid circles. The color misregistration amounts of the pattern images of the other colors in the main scanning direction can be measured based on the straight line L″. Therefore, any pattern images are applicable as long as a plurality of pattern images of the reference color are arranged in the sub-scanning direction so that the virtual reference color position can be assumed based on the straight line L in FIG. 7A and FIG. 7B, the straight line L′ in FIG. 10, and the straight line L″ in FIG. 11B.

Color Misregistration Detection in Sub-Scanning Direction

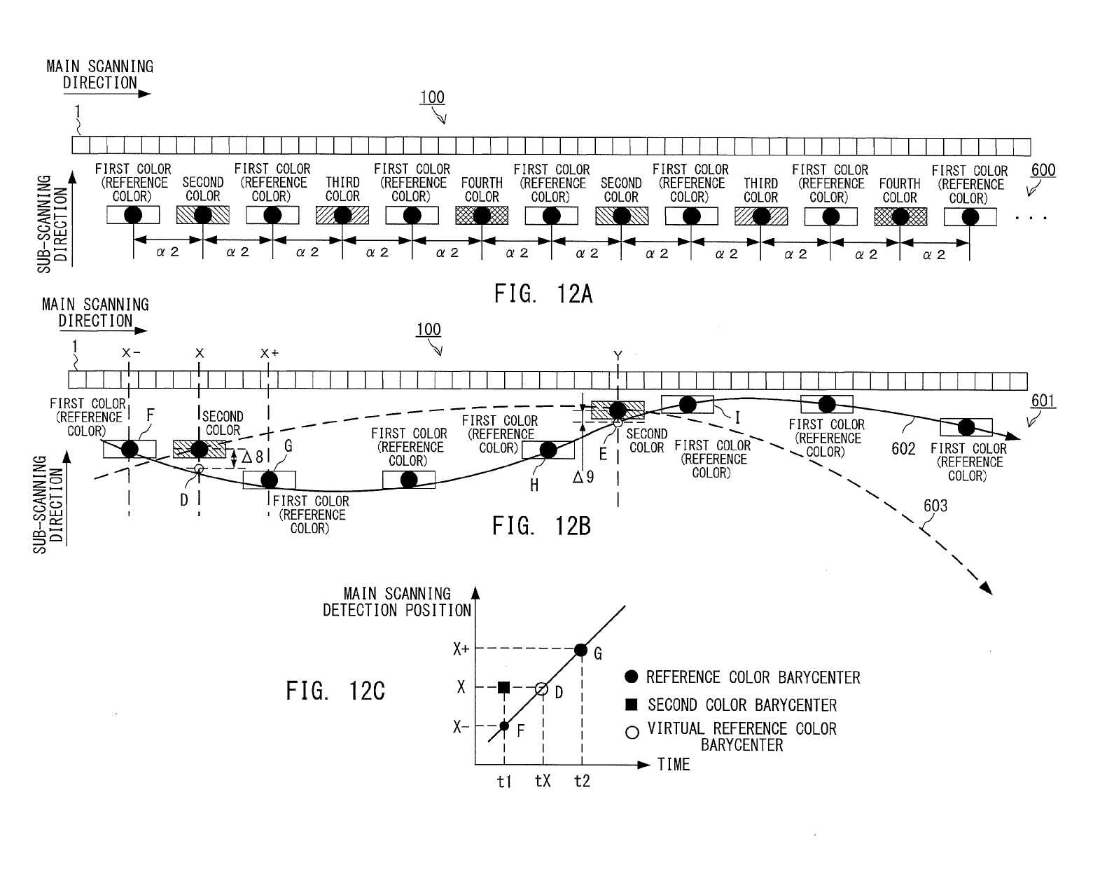

FIG. 12A and FIG. 12B are explanatory views for illustrating pattern images for detecting color misregistration exhibited in the sub-scanning direction, and FIG. 12C is an explanatory graph for showing a relationship between detection timings and positions of pattern images. FIG. 12A is a view for illustrating an example of the pattern images for detecting color misregistration exhibited in the sub-scanning direction. A measurement image 600 illustrated in FIG. 12A is formed so that the pattern images of the reference color and the pattern images of the other colors are arrayed alternately in the main scanning direction. The pattern images of the respective colors are arranged in the main scanning direction at equal intervals α2. The measurement image 600 is formed so that the pattern images of the reference color and the pattern image of the other colors are formed over the entire area of the intermediate transfer belt 9 in the main scanning direction. Center positions indicated by the solid circles are detected as formation positions of the pattern images.

When such measurement images are formed on the intermediate transfer belt 9, the pattern images of the respective colors may be formed at positions shifted in the sub-scanning direction due to differences among the curves or inclinations of the respective scan lines of the exposure devices 5a to 5d. FIG. 12B is a view for illustrating an example of such measurement images 601. In FIG. 12B, the pattern images of the first color being the reference color and the pattern images of the second color being another color are illustrated, and the pattern images of the third color and the pattern images of the fourth color are omitted. FIG. 12B is also an illustration of a scan line 602 for forming the pattern images of the reference color and a scan line 603 for forming the pattern images of the second color. The following description is given of the detection of the color misregistration amount between the pattern images of the first color and the pattern images of the second color.

The color misregistration amount in the sub-scanning direction of the pattern image of the second color located at a position X in the main scanning direction is a color misregistration amount of Δ8 in the sub-scanning direction with respect to a virtual reference color position D at which the pattern image of the reference color is supposed to be formed at the position X in the main scanning direction. The pattern images are formed in the main scanning direction at equal intervals α2, and hence a sub-scanning position of the virtual reference color position D is substantially at the center between the center position of a pattern image F of the reference color and the center position of a pattern image G of the reference color. The controller 300 determines the sub-scanning position of the virtual reference color position D based on an average of the sub-scanning position of the center position of the pattern image F and the sub-scanning position of the center position of the pattern image G. The controller 300 calculates a difference between the sub-scanning position of the virtual reference color position D determined in this manner and the sub-scanning position of the pattern image of the second color, to thereby detect the color misregistration amount of Δ8 in the sub-scanning direction at the position X in the main scanning direction.

FIG. 12C is a graph for showing a relationship between the detection timings and positions of the pattern image F of the reference color, the pattern image of the second color, and the pattern image G of the reference color. At a predetermined time t1, the pattern image F of the reference color (at a position X− in the main scanning direction) and the pattern image of the second color (at a position X in the main scanning direction) are simultaneously detected. At a time t2, the pattern image G of the reference color (at a position X+ in the main scanning direction) is detected. The detection timing of the virtual reference color position D is at the center position between the pattern image F and the pattern image G of the reference color, and is expressed by the following expression.

tX=(t2−t1)/2

Assuming that a rotation speed of the intermediate transfer belt 9 (carrying speed of the image) is P mm/s, a distance in the sub-scanning direction between the pattern image F of the reference color and the virtual reference color position D is P×tX=P×(t2−t1)/2. The position in the sub-scanning direction of the pattern image of the second color is the same as that of the pattern image F of the reference color, and hence the color misregistration amount of the second color in the sub-scanning direction is P×(t2−t1)/2.

In the same manner, the color misregistration amount of the pattern image of the second color at a position Y in the main scanning direction illustrated in FIG. 12B is a color misregistration amount in the sub-scanning direction between the position in the sub-scanning direction of the pattern image of the second color and a virtual reference color position E at the position Y in the main scanning direction. That is, the color misregistration amount of the pattern image of the second color at the position Y is a color misregistration amount of Δ9 in the sub-scanning direction between the virtual reference color position E, which is at the center between the center position of a pattern image H of the reference color and the center position of a pattern image I of the reference color, and the position of the pattern image of the second color. The controller 300 performs such processing on the pattern images of the second to fourth colors over the entire area in the main scanning direction, to thereby be able to detect the color misregistration amounts for the reference color over the entire area in the main scanning direction.

The controller 300 generates correction data for use at the time of color misregistration correction based on the color misregistration amounts in the main scanning direction and the sub-scanning direction, which are measured in the above-mentioned manner, and performs the color misregistration correction based on the correction data at the time of image formation. For example, the pattern images for detecting color misregistration exhibited in the main scanning direction and the pattern images for detecting color misregistration exhibited in the sub-scanning direction are continuously formed on the intermediate transfer belt 9. With this configuration, it is possible to continuously measure the color misregistration amount in the main scanning direction and the color misregistration amount in the sub-scanning direction.

The controller 300 also performs the color misregistration correction after, for example, the image forming apparatus 1 has continuously formed images on 100 sheets. In another case, the controller 300 may perform the color misregistration correction after, for example, an internal temperature of the image forming apparatus 1 has changed by a temperature equal to or larger than a predetermined temperature. Further, the controller 300 may perform the color misregistration correction after a predetermined time period has elapsed since the main power of the image forming apparatus 1 is turned on.

The image forming apparatus 1 having the above-mentioned configuration measures the color misregistration amount through use of the measurement images, which include images of the reference color arranged at predetermined intervals in the main scanning direction and the sub-scanning direction and images of the other colors sandwiched between the images of the reference color. Through use of such measurement images, even when there occurs skew of the intermediate transfer belt 9 or a curve or an inclination of the scan line of any one of the exposure devices 5a to 5d, the image forming apparatus 1 can measure the color misregistration amount of each color from the entire area of the measurement image with high accuracy. Therefore, the image forming apparatus 1 can perform the color misregistration correction with high accuracy, to thereby be able to form a high-quality image on the sheet S.

Influence on Color Misregistration Correction by Positional Relationship Between Light Receiving Element 100-n and Measurement Image

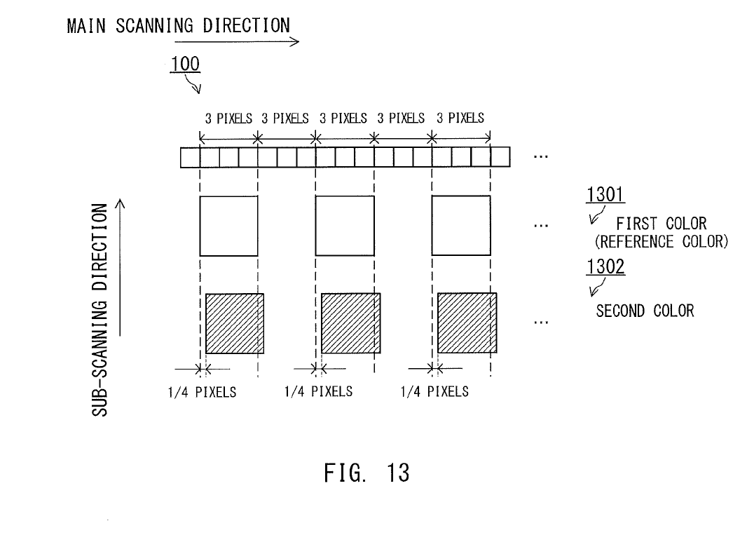

Next, a description is given of influences exerted on position detection of a measurement image by a positional relationship between the measurement image formed on the intermediate transfer belt 9 and the light receiving elements 100-n of the line sensor 100. FIG. 13 is an explanatory view for illustrating a measurement image for use in the measurement of the color misregistration amount in the main scanning direction in the related art.

The measurement image in the related art is formed so that a pattern image group 1301 of the first color being the reference color and a pattern image group 1302 of the second color are arrayed in the sub-scanning direction. The pattern image groups 1301 and 1302 of the respective colors are each formed of a plurality of the pattern images arrayed in the main scanning direction. The pattern images are each formed to have a width corresponding to 3 pixels of the light receiving elements 100-n of the line sensor 100 in the main scanning direction. The interval between each adjacent pair of the pattern images in the main scanning direction is also three pixels of the light receiving elements 100-n of the line sensor 100. In FIG. 13, the pattern image group 1302 of the second color is formed at a position shifted by ¼ pixel in the main scanning direction from the pattern image group 1301 of the first color being the reference color.

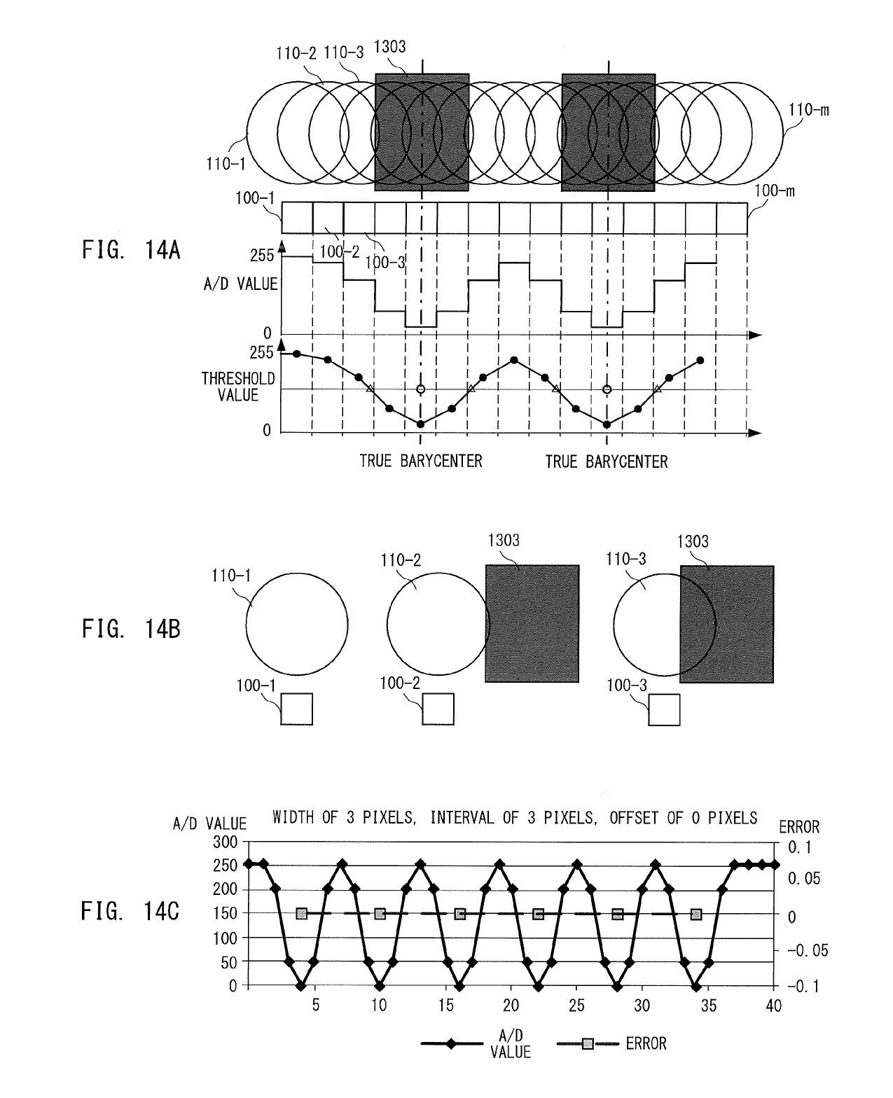

FIG. 14A, FIG. 14B, and FIG. 14C are explanatory diagrams and explanatory graphs for showing such detection results of the measurement images in the related art. FIG. 14A is an explanatory view for illustrating a method of measuring positions (centers) of pattern images 1303. In this embodiment, the surface of the intermediate transfer belt 9 having the measurement images formed thereon has a white color.

In general, the line sensor 100 is formed with an overlap provided between each adjacent pair of detection ranges 110-1 to 110-m of the light receiving elements 100-1 to 100-m, respectively. The symbol “m” is a natural number equal to or smaller than “n”. An output value of the line sensor 100 (light receiving element) is “255” when a white color is detected, and is “0” when a black color is detected. The values of the detection results shown in FIG. 14A are A/D values obtained by performing analog-to-digital conversion on the output values of the light receiving elements 100-1 to 100-m.

The center positions of the pattern images 1303 in the main scanning direction based on the reading results obtained by the line sensor 100 are expressed by the A/D values of each obtained by the light receiving elements 100-1 to 100-m and a threshold value ((50% of the maximum value among the A/D values)=128). That is, a middle point (outlined circle) between intersection points (Δ) between a primary straight line connecting the A/D values (solid circles) and the threshold value is the center position (outlined circle) of the pattern image 1303 in the main scanning direction. In FIG. 14A, the center position (outlined circle) of the pattern image 1303 determined based on the A/D values and the threshold value falls on a true center position (one-dot chain line) of the pattern image 1303. In other words, the center position of the pattern image 1303 in the main scanning direction based on the reading results obtained by the line sensor 100 and the center position of the actual pattern image 1303 are the same position, and there is no error between those two positions.

FIG. 14B is an explanatory view for illustrating positional relationships between the detection ranges 110-1 to 110-3 of the light receiving elements 100-1 to 100-3 and the pattern images 1303. The detection range 110-1 of the light receiving element 100-1 does not include the pattern image 1303. Therefore, the light receiving element 100-1 detects the intermediate transfer belt 9 having a white color. The A/D value of the light receiving element 100-1 is “255”. The detection range 110-2 of the light receiving element 100-2 includes a part of the pattern image 1303. Therefore, the light receiving element 100-2 detects the intermediate transfer belt 9 having a white color and the pattern image 1303. The A/D value of the light receiving element 100-1 is a value slightly smaller than “255”. The detection range 110-3 of the light receiving element 100-3 includes almost half of the pattern image 1303. Therefore, the light receiving element 100-3 detects the intermediate transfer belt 9 having a white color and the pattern image 1303. The A/D value of the light receiving element 100-3 is a value smaller than the A/D value of the light receiving element 100-2.

In this manner, the A/D values are determined based on a proportion of the pattern image within a detection range. FIG. 14C is an explanatory graph for showing such A/D values. In FIG. 14C, the thick solid line is a graph connecting the respective A/D values with the primary straight line. The thick broken line represents errors between the center positions of the pattern images determined by the intersection points, which are calculated based on the primary straight line connecting the A/D values and the threshold value of 50%, and the true center positions being the positions of the medians of the pattern images.

The A/D values shown in FIG. 14C are obtained when, as illustrated in FIG. 14A, the pattern images are formed to have widths and intervals each being an integral multiple of the pitch of the light receiving element with the pattern images and the light receiving elements having their edges aligned with each other. In this case, the primary straight line obtained by connecting the A/D values is bilaterally symmetrical. Therefore, the center position (outlined circle in FIG. 14A) determined based on the intersection point (Δ in FIG. 14A) between the primary straight line and the threshold value falls on the center position (one-dot chain line in FIG. 14A) of the actual pattern image. That is, as shown in the graph of FIG. 14C, an error between the center position determined based on the threshold value and the actual center position of the pattern image is zero pixels. Therefore, it is possible to detect the accurate position of the pattern image based on the threshold value.

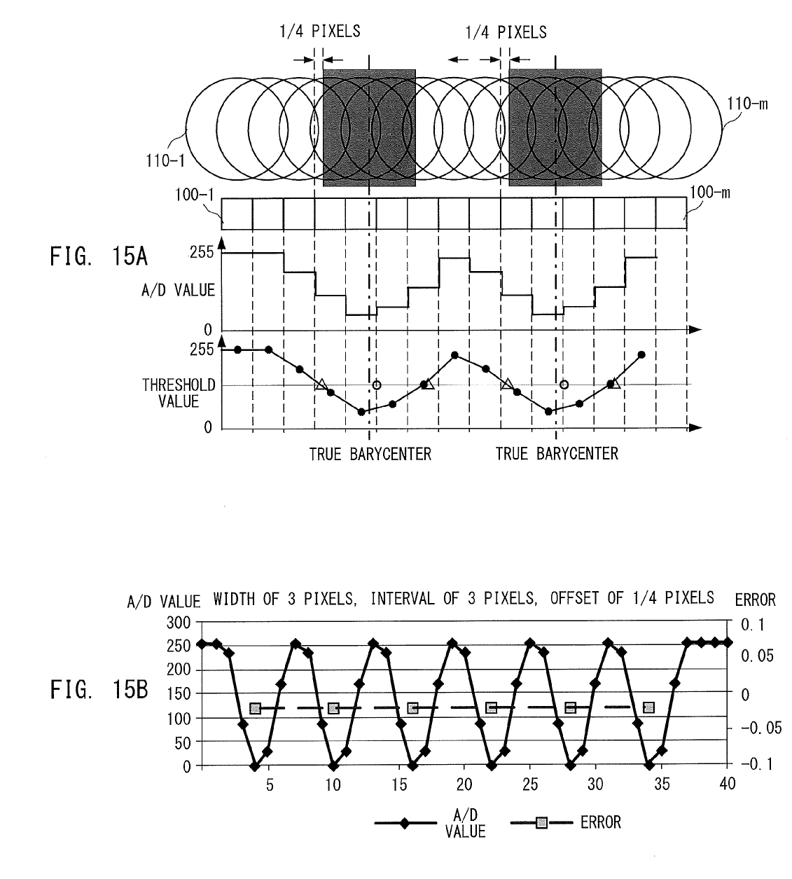

However, the accurate position detection of the pattern image is difficult even when the pattern images and the light receiving elements do not have their edges aligned with each other irrespective of the pattern images formed to have widths and intervals each being an integral multiple of the pitch of the light receiving element 100-m. FIG. 15A and FIG. 15B are an explanatory diagram and explanatory graphs for showing the detection results of the measurement image exhibited when the pattern images and the light receiving elements do not have their edges aligned with each other.

FIG. 15A is an illustration of a case in which the pattern images and the light receiving elements do not have their edges aligned with each other, and the pattern images are read at positions shifted from the state of FIG. 14A in the main scanning direction by ¼ pixel. The positions at which the pattern images are read fall out of alignment, which inhibits the A/D values from becoming bilaterally symmetrical. Therefore, it is indicated in FIG. 15A that the center positions (outlined circles) determined based on the A/D values and the threshold value of 50% do not fall on the true center positions (one-dot chain line) of the pattern images.

It is understood from FIG. 14C and FIG. 15B that, even when the same measurement image is used, an error occurs when the position at which the pattern image is read falls out of alignment. That is, the measurement images including the pattern images formed to have widths and intervals each being an integral multiple of the pitch of the light receiving element 100-m of the line sensor 100 are detected while being displaced from the detection range of the light receiving element, to thereby cause the accurate position detection to become difficult. In view of this, in this embodiment, the measurement images that enable the accurate position detection even when the position of the pattern image falls out of the detection range of the line sensor 100 is used.

Color Misregistration Detection in Main Scanning Direction

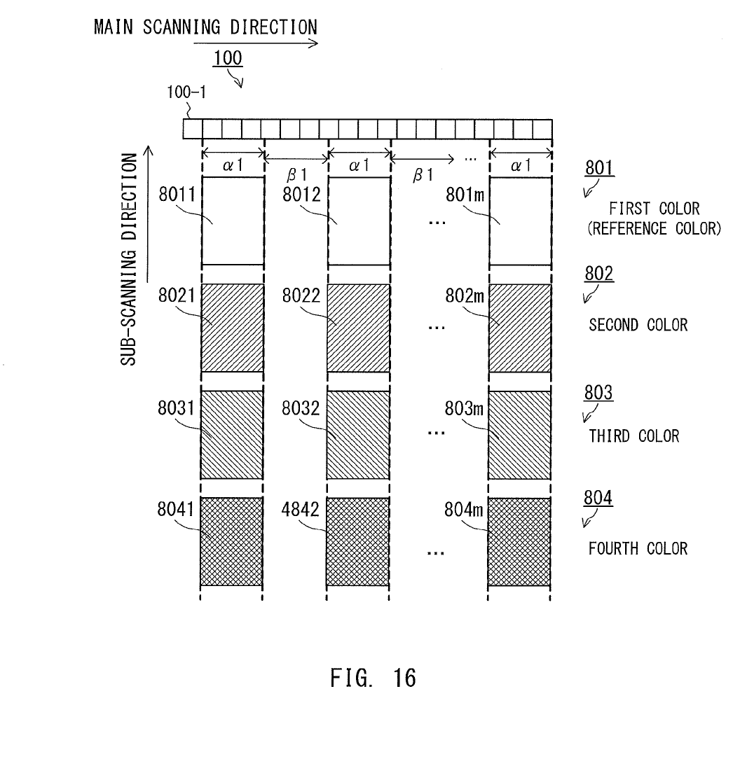

FIG. 16 is a view for illustrating an example of a measurement image for detecting color misregistration exhibited in the main scanning direction in this embodiment. This measurement image is formed so that pattern image groups 801 to 804 respectively corresponding to a plurality of colors are formed in alignment with each other in the sub-scanning direction. The pattern image groups 801 to 804 of the respective colors are each formed of a plurality of pattern images of the same color over the entire area in the main scanning direction. The pattern images are each formed as a rectangle having the width α1 in the main scanning direction, and are arranged so as to have respective sides parallel with one another in any one of the main scanning direction and the sub-scanning direction. The pattern images are arranged at equal intervals β1 in the main scanning direction.

The pattern image group 801 of the first color being the reference color is formed of pattern images 8011 to 801m. The pattern image group 802 of the second color is formed of pattern images 8021 to 802m. The pattern image group 803 of the third color is formed of pattern images 8031 to 803m. The pattern image group 804 of the fourth color is formed of pattern images 8041 to 804m. The pattern images of the pattern image groups 801 to 804 of the respective colors are arranged horizontally in the main scanning direction and vertically in the sub-scanning direction as a whole.

A sum of the width α1 of the pattern image and the intervals β1 is a non-integral multiple of the pitch of the light receiving element 100-m of the line sensor 100. A description is given of a case in which a resolution of the line sensor 100 in the main scanning direction is 600 dpi and the resolution in the main scanning direction of the image forming apparatus 1 for forming a measurement image is 2,400 dpi. When the resolution of the image forming apparatus 1 is used to form a measurement image having the width α1 corresponding to 12 pixels and the interval β1 corresponding to 13 pixels, the pattern images of the measurement image are each formed to have a width corresponding to 3 pixels and an interval corresponding to 3.25 pixels with the resolution of the line sensor 100 in the main scanning direction. The sum of the width α1 of such a pattern image and the interval β1 between each adjacent pair of the pattern images is a non-integral multiple of the pitch of the pixel (pitch of the light receiving element 100-m) of the line sensor 100 in the main scanning direction.

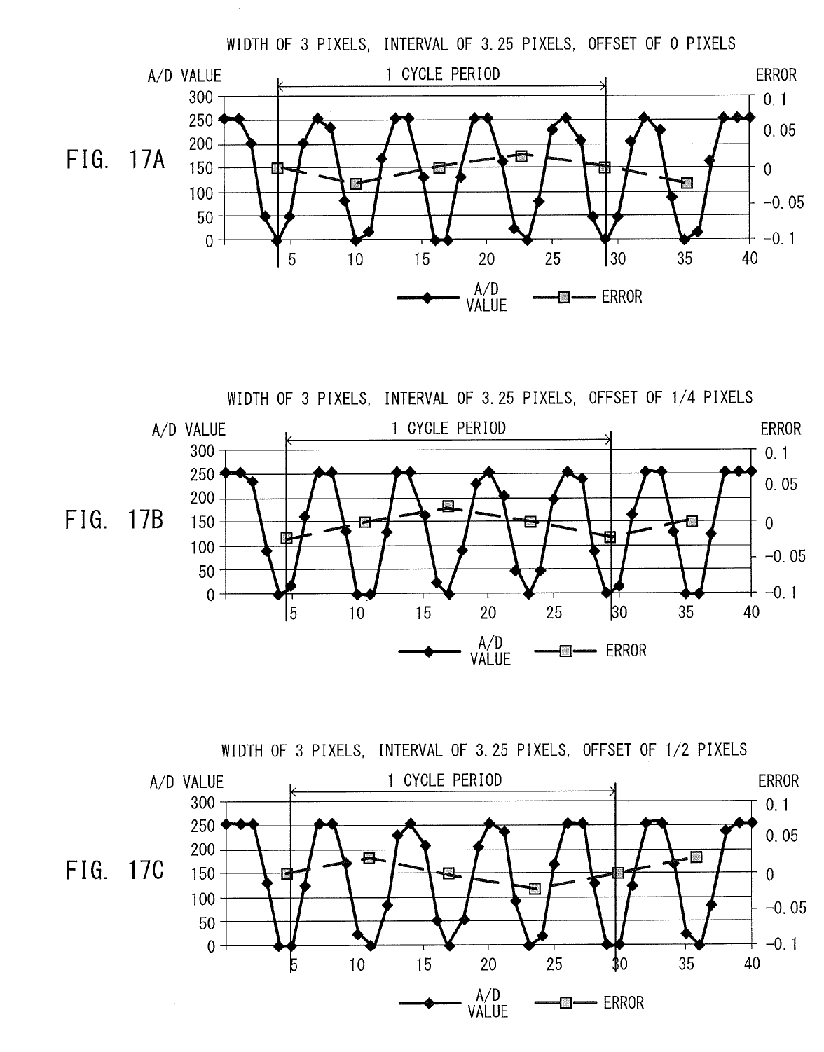

FIG. 17A, FIG. 17B, and FIG. 17C are explanatory graphs for showing the detection results obtained by reading such a measurement image by the line sensor unit 27. FIG. 17A, FIG. 17B, and FIG. 17C are graphs for showing A/D values obtained by performing analog-to-digital conversion on the output values of the line sensor 100 that has read the measurement images and errors between the center positions of the reading results obtained by the line sensor 100 and the true center positions of the pattern images.

FIG. 17A, FIG. 17B, and FIG. 17C are graphs for showing the A/D values and the errors exhibited when the width α1 of the pattern image in the main scanning direction corresponding to 3 pixels of the line sensor 100 in the main scanning direction and the interval β1 between each adjacent pair of the pattern images corresponding to 3.25 pixels of the line sensor 100 in the main scanning direction. In FIG. 17A, the measurement image is read under a state (with the offset being zero pixels) in which a predetermined pixel (for example, first pixel) of the pattern image in the main scanning direction and a light receiving element have their edges aligned with each other. In FIG. 17B, the measurement image is read at a position (with the offset being ¼ pixels) at which the predetermined pixel (for example, first pixel) of the pattern image in the main scanning direction and the light receiving element have their edges displaced by ¼ pixels. In FIG. 17C, the measurement image is read at a position (with the offset being ½ pixels) at which the predetermined pixel (for example, first pixel) of the pattern image in the main scanning direction and the light receiving element have their edges displaced by ½ pixels.

The sum of the width α1 and the interval β1 is a non-integral multiple of the pitch of the light receiving element 100-m of the line sensor 100, and hence the error between the center position determined based on the threshold value and the true center position periodically varies. In FIG. 17A, the detection results of the four pattern images define one cycle period. When an average value of the center positions determined within this one cycle period based on the threshold value is compared with the true center position, the error is zero pixels. In the same manner in FIG. 17B and FIG. 17C, the error between the center position determined based on the threshold value and the true center position periodically varies, and when the average value of the center positions determined within one cycle period based on the threshold value is compared with the true center position, the error is zero pixels. Therefore, it is possible to accurately detect the positions of the pattern images (measurement image) in the main scanning direction.

One cycle period of the error is the cycle period of the detection results of four consecutive pattern images on the grounds that the decimal fraction of the sum of the width α1 and the interval β1 is in increments of ¼ pixels. When the sum of the width α1 and the interval β1 is 6.5 pixels, the decimal fraction is in increments of ½ pixels, and hence one cycle period is the cycle period of the detection results of two pattern images. When the sum of the width α1 and the interval β1 is 6.75 pixels, the decimal fraction is ¾ pixels, but in the same manner as in the case in increments of ¼ pixels, one cycle period is the cycle period of the detection results of the four pattern images.

The controller 300 measures the color misregistration amount based on two results, namely, a result of averaging the center positions of the pattern images of the reference color measured in units of one cycle period being a repetition interval of the error, and a result of averaging the center positions of the pattern images of another color measured in units of one cycle period being the repetition interval of the error. The center position of the pattern image is detected over the entire area in the main scanning direction. Therefore, the controller 300 can measure the color misregistration amount over the entire area of the intermediate transfer belt 9 in the main scanning direction.

As described above, for the measurement images for detecting color misregistration exhibited in the main scanning direction in this embodiment, it is important that the sum of the width α1 of the pattern image in the main scanning direction and the interval β1 between each adjacent pair of the pattern images in the main scanning direction is a non-integral multiple of the pitch of the light receiving element 100-m of the line sensor 100. In this case, the error between the center position determined based on the threshold value and the true center position has periodicity, and hence it is possible to detect the accurate center position of the pattern image by averaging the center positions in units of the cycle period.

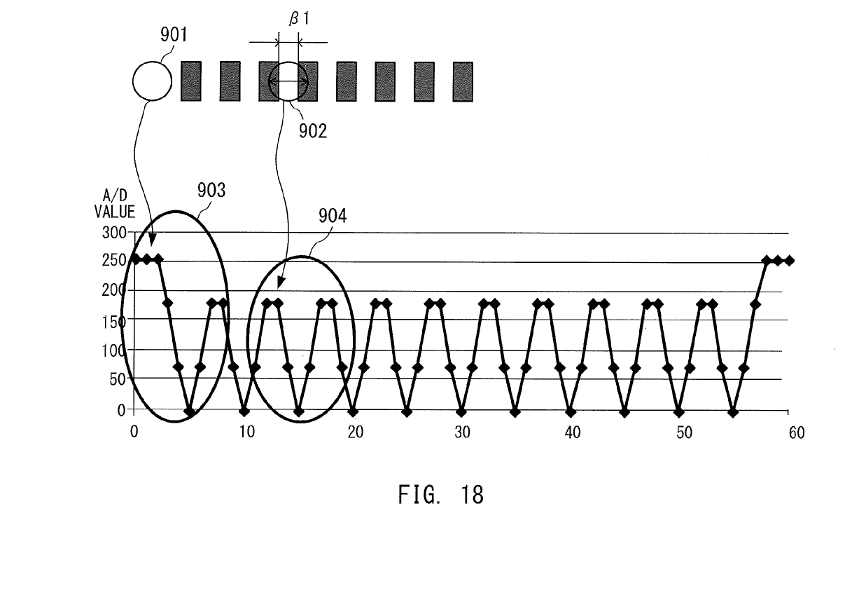

The description is given above on the assumption that the threshold value to be compared with the primary straight line connecting the A/D values is 50% (128) of the maximum value (255) among the A/D values. This threshold value is a value set on the premise that the output values, namely, AD values, of the line sensor 100 have the same level between the intermediate transfer belt 9 outside the measurement images and the intermediate transfer belt 9 between the pattern images. However, when the diameter of the detection range of the light receiving element is larger than the interval β1 between each adjacent pair of the pattern images, the A/D values cannot be detected at the same level between the intermediate transfer belt 9 outside the measurement image and the intermediate transfer belt 9 between the pattern images. In this case, when the threshold value is set to 50% of the maximum value among the A/D values, the center position determined based on the A/D value is shifted from the true center position of the pattern image. FIG. 18 is an explanatory view and an explanatory graph for showing such a center position and such misregistration of the center position.

In a detection range 901 located outside the measurement image, the white color of the intermediate transfer belt 9 is read, and hence the A/D value is “255”. However, when the diameter of the detection range of the light receiving element is larger than the interval β1 between each adjacent pair of the pattern images, a pattern image always falls on a detection range 902 between the pattern images. Therefore, the line sensor 100 cannot detect the intermediate transfer belt 9 by itself, and the A/D value becomes a value smaller than “255” being the maximum value.

For this reason, the inclination of the primary straight line formed of AD values 903 obtained in the detection range 901 located outside the measurement image is different between the falling edge and the rising edge, and a waveform thereof is distorted. Therefore, no matter in which way the threshold value is set, the center position cannot be accurately determined. The inclination of the primary straight line formed of A/D values 904 obtained in the detection range 902 between the pattern images is substantially the same between the falling edge and the rising edge. Therefore, it is possible to accurately determine the center position based on the threshold value. As a result, the A/D values obtained from inside pattern images other than a predetermined number of pattern images at both ends of the measurement image in the main scanning direction are used, to thereby be able to determine the center position more accurately based on the threshold value. This enables the accurate color misregistration correction in the main scanning direction.

Color Misregistration Detection in Sub-Scanning Direction

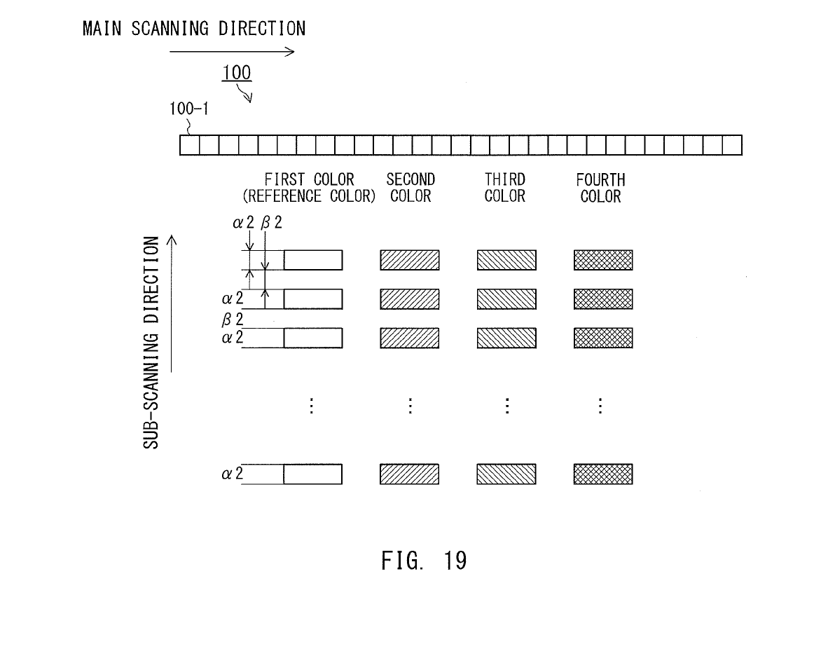

FIG. 19 is an explanatory view for illustrating the measurement image for detecting color misregistration exhibited in the sub-scanning direction. In the same manner as in the case of the measurement image for detecting color misregistration exhibited in the main scanning direction, the measurement image for detecting color misregistration exhibited in the sub-scanning direction also allows the color misregistration amount to be accurately measured based on the relationship between the sum of the width of the pattern image and the interval between each adjacent pair of the pattern images and the pitch of the light receiving element of the line sensor 100. The measurement image for detecting color misregistration exhibited in the sub-scanning direction is formed so that the pattern images of the reference color and the pattern images of other colors are arrayed in the main scanning direction. This measurement image is formed so that pattern images of the same color are formed in alignment with each other in the sub-scanning direction. The pattern images of the respective colors are formed with the width α2 in the sub-scanning direction. The respective pattern images are arrayed with an interval β2 in the sub-scanning direction.

The sum of the width α2 and the interval β2 is a non-integral multiple of a reading pitch of the line sensor 100. The line sensor 100 collectively reads the respective pattern images arrayed in the main scanning direction. The reading pitch is an interval between reading timings of the line sensor 100. The resolution of the line sensor 100 in the sub-scanning direction is determined by the reading pitch.

A description is given of a case in which the resolution of the line sensor 100 in the sub-scanning direction is 600 dpi and the resolution in the sub-scanning direction of the image forming apparatus 1 for forming a measurement image is 2,400 dpi. When the resolution of the image forming apparatus 1 is used to form a measurement image with the width α2 corresponding to 12 pixels and the interval β2 corresponding to 13 pixels, the pattern images of the measurement image are formed to have a width corresponding to 3 pixels and an interval corresponding to 3.25 pixels with the resolution of the line sensor 100 in the main scanning direction. The sum of the width α2 of the pattern image and the interval β2 between each adjacent pair of the pattern images is a non-integral multiple (6.25 times) of the reading pitch of the line sensor 100.

In the same manner as in the main scanning direction, through use of such a measurement image even in the sub-scanning direction, the error between the center position determined based on the threshold value and the true center position periodically varies. In the above-mentioned example, one cycle period is defined by the detection results of the four pattern images. When the average value of the center positions determined within one cycle period based on the threshold value is compared with the true center position, the error is zero pixels. This allows the pattern image (measurement image) to be subjected to the accurate position detection in the sub-scanning direction. Therefore, in this case, the number of pattern images of the measurement image in the sub-scanning direction may be set to a multiple of 4.

One cycle period of the error is the cycle period of the detection results of four consecutive pattern images on the grounds that the decimal fraction of the sum of the width α2 and the interval β2 is in increments of ¼ pixels. When, for example, a process speed is halved so as to support a thick paper, the resolution in the sub-scanning direction is 1,200 dpi unless the reading pitch (resolution) of the line sensor 100 is not changed. In this case, when the resolution of the image forming apparatus 1 is used to form a measurement image with the width α2 corresponding to 12 pixels and the interval β2 corresponding to 13 pixels, the pattern images of the measurement image are formed to have a width corresponding to 6 pixels and an interval corresponding to 6.5 pixels with the resolution of the line sensor 100 in the sub-scanning direction. The sum of the width α2 and the interval β2 is 12.5 pixels. As a result, when the process speed is halved without changing the reading pitches (resolutions) of the measurement image and the line sensor 100, one cycle period of the error is the cycle period of the detection results of two pattern images. Therefore, in this case, it suffices to average the center positions obtained from the A/D values obtained from the detection results of the two pattern images.

When the A/D values are different between the intermediate transfer belt 9 outside the measurement image and the intermediate transfer belt 9 between the pattern images, the determination is performed in the same manner as in the case of the main scanning direction, which is described with reference to FIG. 18. That is, the A/D values obtained from inside pattern images other than a predetermined number of pattern images at both ends of the measurement image in the sub-scanning direction are used, to thereby be able to determine the center position more accurately based on the threshold value. This enables the accurate color misregistration correction.

The controller 300 measures the color misregistration amount in the sub-scanning direction based on two results, namely, the result of averaging the center positions of the pattern images of the reference color measured in units of one cycle period being a repetition interval of the error and the result of averaging the center positions of the pattern images of another color measured in units of one cycle period being the repetition interval of the error.

The image forming apparatus 1 according to this embodiment, which has been described above, can accurately measure the color misregistration amount by using the measurement images illustrated in FIG. 16 and FIG. 19 as the measurement images for detecting color misregistration exhibited in the main scanning direction and the sub-scanning direction irrespective of the detection range of the line sensor 100 and the position of the measurement image. This enables the image forming apparatus 1 to perform the color misregistration correction through use of the line sensor unit 27 with a simple configuration, and to provide an image having high image quality through the accurate color misregistration correction in the main scanning direction and the sub-scanning direction. The measurement image may be formed by combining measurement images exemplified in FIG. 16 and FIG. 19. Through use of such a measurement image, it is possible to efficiently measure the color misregistration amounts exhibited in the main scanning direction and the sub-scanning direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2017-209724, filed Oct. 30, 2017 and No. 2017-209723, filed Oct. 30, 2017 which are hereby incorporated by reference herein in their entirety.

What is claimed is:

1. An image forming apparatus, comprising:
an image bearing member configured to be rotated;
a first image forming unit configured to form an image of a first color on the image bearing member;
a second image forming unit configured to form an image of a second color different from the first color on the image bearing member;
a transfer portion configured to transfer the image of the first color and the image of the second color from the image bearing member onto a sheet;
a line sensor, which includes a plurality of light receiving elements arrayed in a direction orthogonal to a rotation direction of the image bearing member, and is configured to read color patterns, each of which being formed on the image bearing member, the plurality of the color pattern being formed in alignment with each other so as to be spaced apart from each other at a predetermined interval in the direction orthogonal to the rotation direction of the image bearing member; and
a controller configured to:
control the first image forming unit to form a first color pattern of the first color and another first color pattern of the first color, the first color pattern being formed at a position different from a position of the another first color pattern in the rotation direction;
control the second image forming unit to form a second color pattern of the second color, the second color pattern being formed between the first color pattern and the another first color pattern in the rotation direction;
control the line sensor to read the first color pattern, the another first color pattern, and the second color pattern;
detect color misregistration based on reading results of the line sensor; and
control relative positions of an image to be formed by the first image forming unit and an image to be formed by the second image forming unit based on the detected color misregistration.

2. The image forming apparatus according to claim 1,
wherein the controller generates first positional information related to the first color pattern based on reading results of the first color pattern by the line sensor,
wherein the controller generates another first positional information related to the another first color pattern based on reading results of the another first color pattern by the line sensor, and
wherein the controller controls the relative positions based one the first positional information, the another first positional information, and reading results of the second color pattern by the line sensor.

3. The image forming apparatus according to claim 1, wherein the controller is configured to:
determine an amount of color misregistration of the second color pattern based on the first positional information, the another first positional information, and the reading results of the second color pattern obtained by the line sensor; and
control the relative positions based on the determined amount of color misregistration.

4. The image forming apparatus according to claim 1, wherein the plurality of images of the color pattern in the direction orthogonal to the rotation direction each have a width being a non-integral multiple of a pitch of each of the plurality of light receiving elements.

5. The image forming apparatus according to claim 1, wherein the image bearing member includes:
a plurality of rollers; and
a belt stretched around the plurality of rollers.

6. A color misregistration correction method performed by an image forming apparatus,
the image forming apparatus comprising:
an image bearing member configured to be rotated;
a first image forming unit configured to form an image of a first color on the image bearing member;
a second image forming unit configured to form an image of a second color different from the first color on the image bearing member;
a transfer portion configured to transfer the image of the first color and the image of the second color from the image bearing member onto a sheet; and
a line sensor, which includes a plurality of light receiving elements arrayed in a direction orthogonal to a rotation direction of the image bearing member, and is configured to read color patterns, each of which being formed on the image bearing member, the color pattern being formed in alignment with each other so as to be spaced apart from each other at a predetermined interval in the direction orthogonal to the rotation direction of the image bearing member;
the color misregistration correction method comprising:
controlling the first image forming unit to form a first color pattern formed of a plurality of images of the first color and another first color pattern formed of a plurality of images of the first color, the first color pattern being formed at a position different from a position of the another first color pattern in the rotation direction;
controlling the second image forming unit to form a second color pattern formed of a plurality of images of the second color, the second color pattern being formed between the first color pattern and the another first color pattern in the rotation direction;
controlling the line sensor to read the first color pattern, the another first color pattern, and the second color pattern;
detect color misregistration based on reading results of the line sensor; and
controlling relative positions of an image to be formed by the first image forming unit and an image to be formed by the second image forming unit based on the detected color misregistration.
